(19) United States
(12) Patent Application Publication
(10) Pub. No.: US 2025/0279595 A1
(43) Pub. Date: Sep. 4, 2025

(54) ENGAGEMENT STRUCTURE, AND TERMINAL BLOCK

(71) Applicant: FANUC CORPORATION, Yamanashi (JP)

(72) Inventors: Masahiro SAEKI, Yamanashi-ken (JP); Shinichi KUWAHATA, Yamanashi-ken (JP); Jens OESTERHAUS, Detmold (DE); Jan MEIER, Detmold (DE); Ralf SCHUMACHER, Lemgo (DE); Klaus PUESCHNER, Detmold (DE); Torsten DIEKMANN, Leopoldshoehe (DE)

(21) Appl. No.: 18/858,625

(22) PCT Filed: Apr. 28, 2022
(86) PCT No.: PCT/JP2022/019313

§ 371 Date: Oct. 21, 2024

(51) Int. Cl. H01R 9/24

(52) U.S. Cl. CPC H01R 9/24

(57) ABSTRACT

An engagement structure for causing an accommodating member having an opening to engage with an accommodated member which is accommodated in the accommodating member by being inserted into the opening in a rearward direction includes projecting portions and locking holes that engage with one another, and additionally includes dovetail tenons and a dovetail tenon holes that engage with one another, wherein the dovetail tenons engage with the dovetail tenon holes before the projecting portions come into contact with an opening edge of the opening when the accommodated member is being inserted into the accommodating member.

### TECHNICAL FIELD

The present invention relates to an engagement structure and a terminal block provided with the engagement structure.

### BACKGROUND ART

JP 2014-135280 A discloses a frame and a mounting portion. The frame has a dovetail block (dovetail tenon). The mounting portion has a dovetail groove (dovetail hole). The dovetail block and the dovetail groove are engaged with each other, whereby the frame and the mounting portion are engaged with each other.

### SUMMARY OF THE INVENTION

An accommodated member is accommodated in an accommodating member through an opening of the accommodating member. A dovetail hole is formed in the accommodating member from an opening end of the opening in the insertion direction of the accommodated member. In addition, the dovetail tenon is formed on the accommodated member in the insertion direction.

The dovetail tenon and the dovetail hole are engaged with each other when the accommodated member is accommodated in the accommodating member. Thus, the accommodating member and the accommodated member can be engaged with each other while accommodating the accommodated member in the accommodating member.

Here, a problem arises in that the engagement between the dovetail hole and the dovetail tenon is easily released when the accommodated member moves relative to the accommodating member in the direction opposite to the insertion direction. For example, in the state where the accommodated member is accommodated in the accommodating member, the opening of the accommodating member is directed downward. In this case, the accommodated member is moved relative to the accommodating member in the direction opposite to the insertion direction under the action of gravity. As a result, there is a concern that the engagement between the dovetail hole and the dovetail tenon will be released, and the accommodated member will be dropped from the accommodating member.

The present invention has the object of solving the aforementioned problem.

A first aspect of the present invention is an engagement structure for engaging an accommodating member including an opening, with an accommodated member, the accommodated member being accommodated in the accommodating member by being inserted into the opening in an insertion direction, the engagement structure including a latch structure and a dovetail structure, wherein the latch structure includes a locking hole formed in the accommodating member at a position spaced from an opening end of the opening in the insertion direction, and a protruding portion provided on the accommodated member in accordance with a location of the locking hole in the accommodating member and configured to engage with the locking hole so as to restrict relative movement of the accommodated member with respect to the accommodating member in an opposite direction that is opposite to the insertion direction, wherein the dovetail structure includes a dovetail tenon provided at an end of the accommodated member, and a dovetail hole formed in the accommodating member from the opening end in the insertion direction and configured to engage with the dovetail tenon while allowing the dovetail tenon to move to a predetermined position in the insertion direction, and wherein in a case that the accommodated member is inserted into the accommodating member, the dovetail tenon engages with the dovetail hole before the protruding portion and the opening end come into contact with each other.

A second aspect of the present invention is a terminal block equipped with a housing including an opening, and a module that is accommodated in the housing by being inserted into the opening in an insertion direction, the terminal block including a locking hole formed in the housing at a position spaced from an opening end of the opening in the insertion direction, a protruding portion provided on the module in accordance with a location of the locking hole in the housing and configured to engage with the locking hole so as to restrict relative movement of the module with respect to the housing in an opposite direction that is opposite to the insertion direction, a dovetail tenon provided at an end of the module, and a dovetail hole formed in the housing from the opening end in the insertion direction and configured to engage with the dovetail tenon while allowing the dovetail tenon to move to a predetermined position in the insertion direction, wherein in a case that the module is inserted into the housing, the dovetail tenon engages with the dovetail hole before the protruding portion and the opening end come into contact with each other.

According to the present invention, any concern that the accommodated member may fall out of the accommodating member is reduced.

### BRIEF DESCRIPTION OF DRAWINGS

FIG. 1A is a perspective view of an I/O unit according to an embodiment, and FIG. 1B is an exploded view of the I/O unit;

FIG. 2 is an exploded view of a terminal block;

FIG. 3 is a left side view of the terminal block;

FIG. 4 is a schematic view showing a state in which a tip of a dovetail tenon has reached an open end of a housing in a module accommodating operation in the housing;

FIG. 5 is a schematic diagram showing the housing and a module that is further moved in a rearward direction from the state of FIG. 4;

FIG. 6A is a schematic diagram showing the housing and the module that is further moved in the rearward direction from the state of FIG. 5, and FIG. 6B is a view of the terminal block shown in FIG. 6A as viewed from another direction;

FIG. 7A is a schematic diagram of a terminal block according to a comparative example, and FIG. 7B is a view of the terminal block shown in FIG. 7A as viewed from another direction;

FIG. 8 is a diagram showing a module according to an Exemplary Modification 1;

FIG. 9 is a diagram showing a module and a housing according to an Exemplary Modification 2; and

FIG. 10 is a diagram showing a module and a housing according to an Exemplary Modification 3.

### DETAILED DESCRIPTION OF THE INVENTION

### Embodiment

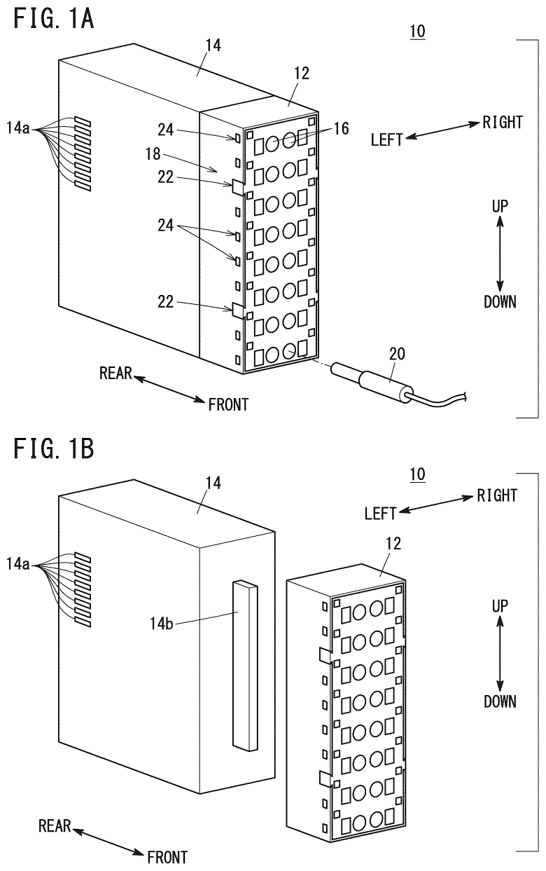

FIG. 1A is a perspective view of an I/O unit 10 according to an embodiment. FIG. 1B is an exploded view of the I/O unit 10.

The arrows shown in the drawings indicate directions (front, rear, left, right, up, and down) used in the following description. The up-down direction (first direction), the left-right direction (second direction), and the front-rear direction are orthogonal to each other. The left-right direction and the front-rear direction are parallel to, for example, a horizontal plane.

The I/O unit 10 is provided in a communication system including, for example, a PLC (Programmable Logic Controller). The I/O unit 10 is an electronic device (input/output device) including a terminal block 12 and a signal processing unit 14.

The signal processing unit 14 includes a plurality of contactors 14a and a signal processing module 14b.

The plurality of contactors 14a are terminal groups disposed on both sides of the signal processing unit 14 in the left-right direction. The plurality of contactors 14a disposed on the left side of the signal processing unit 14 are provided to electrically connect to another I/O unit 10 disposed on the left side of the signal processing unit 14. The plurality of contactors 14a disposed on the right side of the signal processing unit 14 are provided to electrically connect to another I/O unit 10 disposed on the right side of the signal processing unit 14.

In the present embodiment, the I/O unit 10 is substantially symmetrical in the left-right direction. In view of this, the right side portion of the I/O unit 10 is not shown.

The signal processing module 14b is a module that performs processing required of the I/O unit 10 in the above-described communication system. The signal processing module 14b includes an electric circuit such as a control IC (Integrated Circuit). The signal processing module 14b is electrically connected to the plurality of contactors 14a in the signal processing unit 14.

The terminal block 12 is disposed in front of the signal processing unit 14. The terminal block 12 is mounted on the signal processing unit 14 from the front side of the signal processing unit 14 in the rearward direction. The terminal block 12 includes a plurality of connection ports 16 and an engagement structure 18.

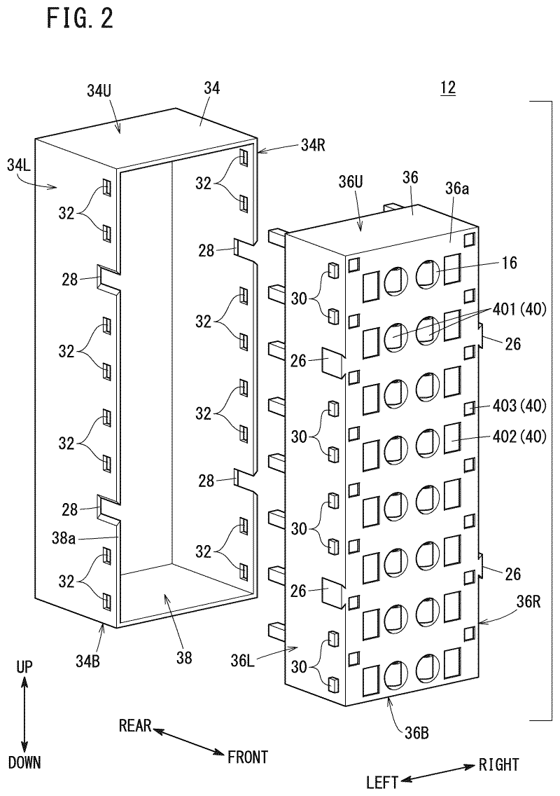

Each of the plurality of connection ports 16 is a portion to which an external terminal 20 is connected. The external terminal 20 is a terminal provided in, for example, various actuators used for a machine tool, a robot, etc., and various detectors and the like. A terminal (401) for electrical connection with the external terminal 20 is disposed in each of the connection ports 16 (see FIG. 2). The external terminal 20 is connected to the signal processing module 14b through the terminal.

The engagement structure 18 includes dovetail structures 22 and latch structures 24. Each of the dovetail structures 22 has a dovetail tenon 26 and a dovetail hole 28 (see FIG. 2). Each of the latch structures 24 includes a protruding portion 30 and a locking hole 32 (see FIG. 2).

The number of the dovetail structures 22 and the latch structures 24 is not particularly limited. The engagement structures 18 shown in FIGS. 1A (FIG. 1B) include, for illustration purposes, the plurality of dovetail structures 22 and the plurality of latch structures 24.

FIG. 2 is an exploded view of the terminal block 12.

The terminal block 12 may be divided into a housing 34 and a module 36.

The housing 34 is an accommodating member for accommodating the module 36. The housing 34 is formed with an opening 38, a plurality of dovetail holes 28, and a plurality of locking holes 32. The module 36 is inserted into the housing 34 through the opening 38. The opening direction of the opening 38 is a forward direction. Accordingly, an opening end 38a of the opening 38 is located at a front end of the housing 34.

The module 36 is inserted into the housing 34 from the front side of the housing 34 in the rearward direction. In this case, the insertion direction of the module 36 is the rearward direction.

Each of the plurality of dovetail holes 28 is a notch formed in the housing 34 from the opening end 38a of the opening 38 in the rearward direction. The plurality of dovetail holes 28 are formed in the side portions of the housing 34 in the left-right direction and the up-down direction. In the present embodiment, a case where the plurality of dovetail holes 28 are formed in both sides of the housing 34 in the left-right direction will be described.

The plurality of locking holes 32 are formed in the side portions of the housing 34 where the plurality of dovetail holes 28 are formed. That is, in the case that the plurality of dovetail holes 28 are provided in a left side portion 34L and a right side portion 34R of the housing 34, the plurality of locking holes 32 are also provided in the left side portion 34L and the right side portion 34R of the housing 34. In the case that the plurality of dovetail holes 28 are arranged in an upper side portion 34U of the housing 34, the plurality of locking holes 32 are also arranged in the upper side portion 34U of the housing 34. In the case that the plurality of dovetail holes 28 are arranged in a lower side portion 34B of the housing 34, the plurality of locking holes 32 are also arranged in the lower side portion 34B of the housing 34.

Each of the plurality of locking holes 32 is disposed in a location of the housing 34 away from the opening end 38a in the insertion direction. That is, in the present embodiment, each of the locking holes 32 is disposed rearward of the opening end 38a.

It is preferable for the material of the housing 34 to include a flexible material. The flexible material includes, for example, a resin material. This allows the housing 34 to deform to a certain extent in accordance with the force applied to the housing 34.

The module 36 is an accommodated member accommodated in the housing 34. The module 36 includes a plurality of components 40.

The plurality of components 40 include, for example, terminals 401 arranged in the connection ports 16. However, the plurality of components 40 may further include a release operation element 402 and a light guide element 403.

The release operation element 402 is an operation element operated by an operator to release the connection between the connection port 16 and the external terminal 20 connected to the connection port 16. The release operation element 402 is, for example, a pusher. The terminal block 12 may include a plurality of release operation elements 402. Accordingly, the plurality of components 40 may include the plurality of release operation elements 402.

For example, the light guide element 403 is an element that guides light from a predetermined light source to a lamp provided in the terminal block 12 in order to turn on the lamp. The light guide element 403 is, for example, a light pipe. The terminal block 12 may include a plurality of light guide elements 403. Accordingly, the plurality of components 40 may include a plurality of light guide elements 403.

The module 36 is formed with a plurality of dovetail tenons 26 and the plurality of protruding portions 30.

The plurality of dovetail tenons 26 are provided on the sides of the module 36 in accordance with the locations of the plurality of dovetail holes 28 in the housing 34. That is, in the case that the plurality of dovetail holes 28 are arranged in the left side portion 34L and the right side portion 34R of the housing 34, the plurality of dovetail tenons 26 are arranged in a left side portion 36L and a right side portion 36R of the module 36. In the case that the plurality of dovetail holes 28 are arranged in the upper side portion 34U of the housing 34, the plurality of dovetail tenons 26 are also arranged in an upper side portion 36U of the module 36. In the case that the plurality of dovetail holes 28 are arranged in the lower side portion 34B of the housing 34, the plurality of dovetail tenons 26 are also arranged in the lower side portion 36B of the module 36.

Each of the plurality of dovetail tenons 26 extends in the insertion direction from an end of the module 36 that faces opposite to the insertion direction. That is, in the present embodiment, each of the dovetail tenons 26 extends in the rearward direction from an end 36a of the module 36 facing in the forward direction.

The plurality of protruding portions 30 are provided on the sides of the module 36 in accordance with the locations of the plurality of locking holes 32 in the housing 34. That is, in the case that the plurality of locking holes 32 are provided in the left side portion 34L and the right side portion 34R of the housing 34, the plurality of protruding portions 30 are provided in the left side portion 36L and the right side portion 36R of the module 36. In the case that the plurality of locking holes 32 are arranged in the upper side portion 34U of the housing 34, the plurality of protruding portions 30 are also arranged in the upper side portion 36U of the module 36. In the case that the plurality of locking holes 32 are arranged in the lower side portion 34B of the housing 34, the plurality of protruding portions 30 are also arranged in the lower side portion 36B of the module 36.

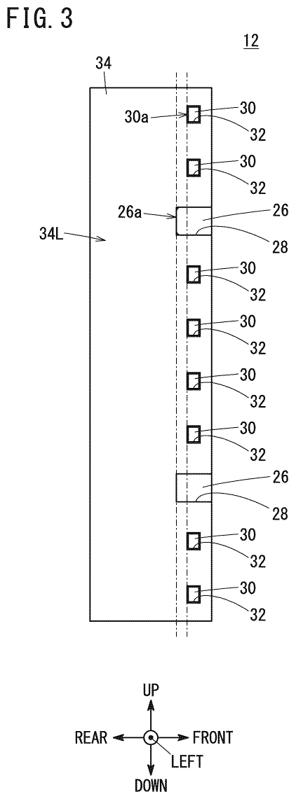

FIG. 3 is a left side view of the terminal block 12.

The plurality of dovetail tenons 26 are provided corresponding to the dovetail holes 28 that are different from each other. Each of the dovetail tenons 26 engages the corresponding dovetail hole 28 in the case that the module 36 is accommodated in the housing 34.

Since the respective dovetail holes 28 are long in the insertion direction, each of the dovetail holes 28 allows the dovetail tenon 26 to move to a certain extent in the insertion direction while engaging with the corresponding dovetail tenon 26. Each of the dovetail holes 28 allows the corresponding dovetail tenon 26 to move to a predetermined position in the insertion direction. For example, the predetermined positions are positions where both side portions (36L, 36R) of the module 36 in the left-right direction are completely accommodated in the housing 34.

The engagement of the dovetail tenons 26 and the dovetail holes 28 restricts the relative movement of the module 36 with respect to the housing 34 in a direction perpendicular to the insertion direction. For example, in the case of the present embodiment, the engagement between the dovetail tenons 26 and the dovetail holes 28 restricts the relative movement of the module 36 with respect to the housing 34 in the up-down direction and the left-right direction.

Further, the engagement between the dovetail tenons 26 and the dovetail holes 28 restricts the side portion of the housing 34 where the dovetail hole 28 is formed from being bent. For example, in the case of the present embodiment, the engagement between the dovetail tenons 26 of the left side portion 36L of the module 36 and the dovetail holes 28 of the left side portion 34L of the housing 34 restricts the left side portion 34L of the housing 34 from being bent. For example, in the case of the present embodiment, the engagement between the dovetail tenons 26 of the right side portion 36R of the module 36 and the dovetail holes 28 of the right side portion 34R of the housing 34 restricts the right side portion 34R of the housing 34 from being bent.

The plurality of protruding portions 30 are provided corresponding to the locking holes 32 that are different from each other. Each of the protruding portions 30 engages the corresponding locking hole 32 in the case that the module 36 is accommodated in the housing 34.

The engagement of the protruding portions 30 with the locking holes 32 restricts the relative movement of the module 36 with respect to the housing 34 in the insertion direction and the direction opposite to the insertion direction. For example, in the case of the present embodiment, the engagement between the protruding portions 30 and the locking holes 32 restricts the relative movement of the module 36 with respect to the housing 34 in the front-rear direction.

The engagement of the protruding portions 30 with the locking holes 32 restricts the relative movement of the module 36 with respect to the housing 34, in the extending direction of the side portion of the housing 34 where the locking holes 32 are formed. For example, in the case of the present embodiment, the left and right side portions (34L, 34R) of the housing 34 extend in the up-down direction and the front-rear direction. Accordingly, the engagement between the protruding portions 30 and the locking holes 32 restricts the relative movement of the module 36 with respect to the housing 34 in the up-down direction and the front-rear direction.

In the above-mentioned terminal block 12, the engagement between the protruding portions 30 and the locking holes 32 restricts the relative movement of the module 36 with respect to the housing 34 in the front-rear direction. That is, the latch structure 24 (the protruding portion 30 and the locking hole 32) can restrict the relative movement of the module 36 with respect to the housing 34, in the insertion direction in which the movement of the dovetail structure 22 (the dovetail tenon 26 and the dovetail hole 28) cannot be restricted. This prevents, for example, the module 36 from inadvertently falling out of the housing 34 through the opening 38.

The engagement of the dovetail tenons 26 and the dovetail holes 28 restricts the relative movement of the module 36 with respect to the housing 34 in the up-down direction. Further, the engagement between the protruding portions 30 and the locking holes 32 more strongly restricts the relative movement of the module 36 with respect to the housing 34 in the up-down direction.

Further, the engagement between the dovetail tenons 26 and the dovetail holes 28 restricts the relative movement of the module 36 with respect to the housing 34 in the left-right direction. That is, the dovetail structure 22 (the dovetail tenon 26 and the dovetail hole 28) can restrict the relative movement of the module 36 with respect to the housing 34, in the direction in which the latch structure 24 (the protruding portion 30 and the locking hole 32) cannot restrict the movement. By restricting the relative movement of the module 36 with respect to the housing 34 in the left-right direction, for example, the engagement between the protruding portion 30 and the locking hole 32 is prevented from being released inadvertently due to the relative movement.

In addition, the engagement between the dovetail tenons 26 and the dovetail holes 28 restricts the housing 34 from being bent in the left-right direction. This prevents the engagement between the protruding portions 30 and the locking holes 32 from being released inadvertently due to the bending.

The terminal block 12 can restrict the relative movement of the module 36 with respect to the housing 34 in all directions of the front-rear direction, the left-right direction, and the up-down direction. In addition, the state in which the module 36 is accommodated in the housing 34 can be maintained more reliably.

Each of the dovetail tenons 26 has a tip 26a in the insertion direction. Each of the protruding portions 30 has a tip 30a in the insertion direction. In this case, with respect to the dovetail tenons 26 and the protruding portions 30 disposed on the same side of the module 36, it is preferable for the tips 26a of the dovetail tenons 26 to be located further in the insertion direction relative to the tips 30a of the protruding portions 30. That is, in the case of the present embodiment, it is preferable for each of the tips 26a of the dovetail tenons 26 to be located rearward of each of the tips 30a of the plurality of protruding portions 30 in each of the left side portion 36L and the right side portion 36R of the module 36 (see also FIG. 3).

The process of accommodating operation the module 36 in the housing 34 will be described below, including the reason for the above positional relationship. In the following description, the tips 26a of the dovetail tenons 26 are located rearward of the tips 30a of the protruding portions 30.

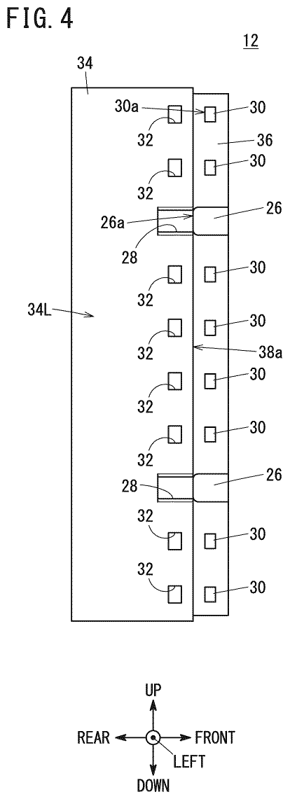

FIG. 4 is a schematic diagram showing a state in which the tips 26a of the dovetail tenons 26 have reached the opening end 38a of the housing 34 in the accommodating operation of the module 36 in the housing 34.

As previously described, the module 36 is accommodated in the housing 34 through the opening 38 of the housing 34. By moving the module 36 from the front to the rear of the housing 34, the tip 26a of each of the plurality of dovetail tenons 26 reaches the opening end 38a of the housing 34. In this state, the tip 30a of each of the plurality of protruding portions 30 does not reach the opening end 38a.

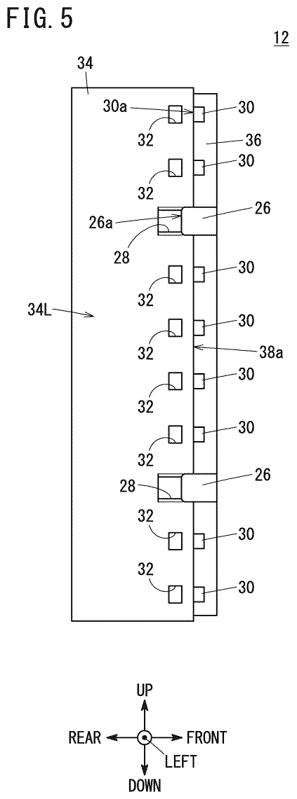

FIG. 5 is a schematic diagram showing the housing 34 and the module 36 further moved in the rearward direction from the state of FIG. 4.

In FIG. 5, the tip 30a of each of the plurality of protruding portions 30 reaches the opening end 38a. In this state, the end portion of each of the plurality of dovetail tenons 26 is engaged with the dovetail hole 28.

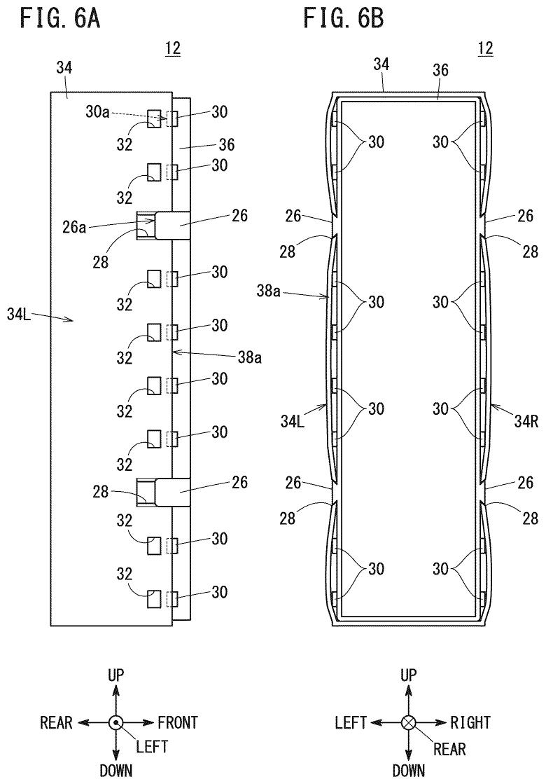

FIG. 6A is a schematic diagram showing the housing 34 and the module 36 further moved in the rearward direction from the state of FIG. 5. FIG. 6B is a view of the terminal block 12 shown in FIG. 6A as viewed from another direction.

FIG. 6B is a view of the terminal block 12 shown in FIG. 6A as seen from the front. However, in order to avoid the complicated illustration, the plurality of connection ports 16, the components 40, and the like are not omitted.

After the tip 30a of each of the plurality of protruding portions 30 reaches the opening end 38a, the tip 30a of each protruding portion 30 enters the housing 34 by moving the module 36 further in the rearward direction.

Each of the plurality of protruding portions 30 that have entered the housing 34 presses the housing 34 in the protruding direction in which the protruding portions 30 each protrude from the inside of the housing 34. For example, in the case of the present embodiment, the plurality of protruding portions 30 arranged on the left side portion 36L of the module 36 protrude in the left direction. Also, in the case of the present embodiment, the plurality of protruding portions 30 arranged on the right side portion 36R of the module 36 protrude in the right direction.

Therefore, the housing 34 receives forces in directions in which the housing 34 is pushed and spread in the left-right direction from the plurality of protruding portions 30. The housing 34 deforms in accordance with the forces received from the plurality of protruding portions 30. However, as described above, the engagement of the dovetail tenons 26 and the dovetail holes 28 restricts both of the side portions (34L, 34R) of the housing 34 in the left-right direction from being bent. Therefore, the housing 34 does not bend greatly in the left-right direction.

Before and after the housing 34 is deformed in accordance with the shape of the protruding portions 30, each of the dovetail tenons 26 continues to be moved in the rearward direction along the corresponding dovetail hole 28.

When the module 36 is further moved in the rearward direction from the state shown in FIGS. 6A and 6B, each of the plurality of protruding portions 30 reaches the corresponding locking hole 32. As a result, the plurality of protruding portions 30 and the plurality of locking holes 32 are engaged with each other. That is, the terminal block 12 in the state shown in FIG. 3 is obtained.

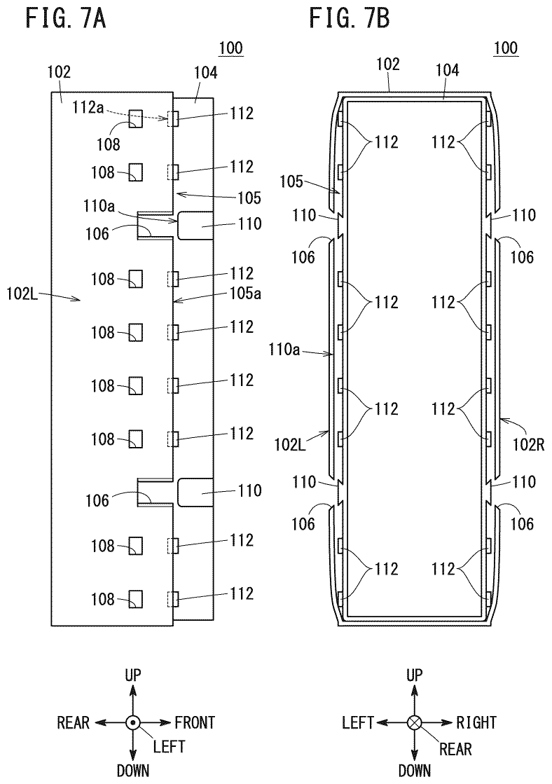

FIG. 7A is a schematic diagram of a terminal block 100 according to a comparative example.

The terminal block 100 includes a housing 102 and a module 104.

The housing 102 includes an opening 105, a plurality of dovetail holes 106, and a plurality of locking holes 108. The opening direction of the opening 105 is a forward direction. An opening end 105a of the opening 105 is located at a front end of the housing 102. The housing 102 has flexibility.

The module 104 includes a plurality of dovetail tenons 110 and a plurality of protruding portions 112. The module 104 is accommodated in the housing 102 from the front side of the housing 102 in the rearward direction.

The plurality of dovetail tenons 110 are provided corresponding to the dovetail holes 106 that are different from each other. The plurality of protruding portions 112 are arranged corresponding to the locking holes 108 that are different from each other.

In this case, tips 110a of the respective dovetail tenons 110 in the rearward direction are located forward of tips 112a of the protruding portions 112 in the rearward direction. Accordingly, in the case that the module 104 is accommodated in the housing 102, the protruding portions 112 enter the housing 102 before the dovetail tenons 110 and the dovetail holes 106 are engaged with each other.

FIG. 7B is a view of the terminal block 100 shown in FIG. 7A as viewed from another direction.

As the protruding portions 112 enter the housing 102, the housing 102 deforms. Here, the housing 102 is deformed before the dovetail holes 106 and the locking holes 108 are engaged with each other. Therefore, the position of the edge portion of each of the dovetail holes 106 may be greatly changed in accordance with the deformation of the housing 102.

For instance, in the example of FIG. 7B, the edge portions of the plurality of dovetail holes 106 arranged in a left side portion 102L of the housing 102 are significantly shifted leftward relative to the dovetail tenons 110. In addition, the edge portions of the plurality of dovetail holes 106 arranged in a right side portion 102R of the housing 102 are significantly shifted rightward relative to the dovetail tenons 110. As a result, in the comparative example, it is difficult to engage the plurality of dovetail holes 106 with the plurality of dovetail tenons 110.

In this regard, according to the present embodiment, with respect to the dovetail tenons 26 and the protruding portions 30 disposed on the same side of the module 36, the tips 26a of the dovetail tenons 26 are located further in the insertion direction relative to the tips 30a of the protruding portions 30. As a result, the dovetail tenons 26 and the dovetail holes 28 are engaged with each other before the protruding portions 30 deform the housing 34. That is, the engagement between the dovetail tenons 26 and the dovetail holes 28 is not hindered by the latch structure 24. Therefore, the operator can easily assemble the terminal block 12 that can more reliably maintain the state in which the module 36 is accommodated in the housing 34.

### Exemplary Modifications

Hereinafter, a description will be given concerning exemplary modifications of the above-described embodiment. However, in the description that follows, explanations that overlap with those of the above-described embodiment will be omitted insofar as possible. Unless otherwise specified, the same reference numerals as in the above-described embodiment are used in referring to the elements that have already been described in the embodiment.

### (Exemplary Modification 1)

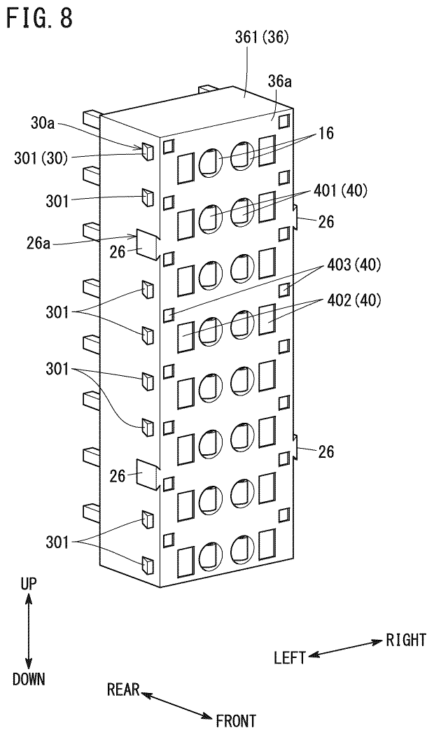

FIG. 8 is a diagram showing a module 361 (36) according to an Exemplary Modification 1. In order to simplify the description, the illustration of portions that are not mentioned in the following description is omitted insofar as possible.

The shape of the protruding portions 30 provided in the module 36 may be modified. That is, the module 361 includes a plurality of protruding portions 301 (30). Each of the protruding portions 301 is inclined so that the thickness thereof in the protruding direction becomes smaller in the insertion direction. For example, the module 361 is accommodated in the housing 34 in the rearward direction. In this case, each of the protruding portions 301 is inclined so that the thickness thereof in the protruding direction becomes smaller in the rearward direction.

By inclining the respective protruding portions 301 as described above, the protruding portions 301 can be smoothly inserted into the housing 34 in the case that the module 361 is accommodated in the housing 34.

In addition, in a range where a portion of each of the protruding portions 301 abutting against the opening end 38a is located forward of the tip 26a of each of the dovetail tenons 26, the tip 30a of each of the protruding portions 301 may be located rearward of the tip 26a of each of the dovetail tenons 26. In addition, within the same range, the tip 30a of each of the protruding portions 301 and the tip 26a of each of the dovetail tenons 26 may be disposed at substantially the same position in the front-rear direction.

### (Exemplary Modification 2)

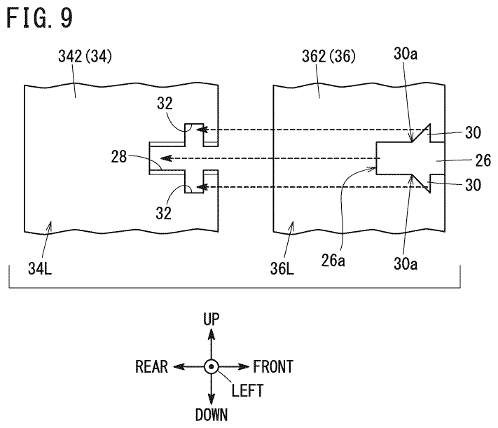

FIG. 9 is a diagram showing a module 362 (36) and a housing 342 (34) according to an Exemplary Modification 2. FIG. 9 shows a part of a left side portion 36L of the module 362 and a part of a left side portion 34L of the housing 342.

The module 362 includes the constituent elements of the module 36 (see the embodiment). However, a dovetail tenon 26 and protruding portions 30 of the module 362 are connected to each other. A plurality of protruding portions 30 may be connected to a single dovetail tenon 26. For instance, in the example shown in FIG. 9, a plurality of protruding portions 30 are arranged so as to sandwich a single dovetail tenon 26 in a direction perpendicular to the insertion direction.

The housing 342 includes the constituent elements of the housing 34 (see the embodiment). The dovetail hole 28 and the locking holes 32 of the housing 342 are arranged in accordance with the locations of the dovetail tenon 26 and the protruding portions 30 of the module 362. For example, the dovetail hole 28 and the locking holes 32 of the housing 342 are connected to each other.

In the case that the module 362 is provided with the plurality of protruding portions 30, the plurality of protruding portions 30 may include both the protruding portions 30 that are connected to the dovetail tenon 26 and the protruding portions 30 that are not connected to the dovetail tenon 26.

### (Exemplary Modification 3)

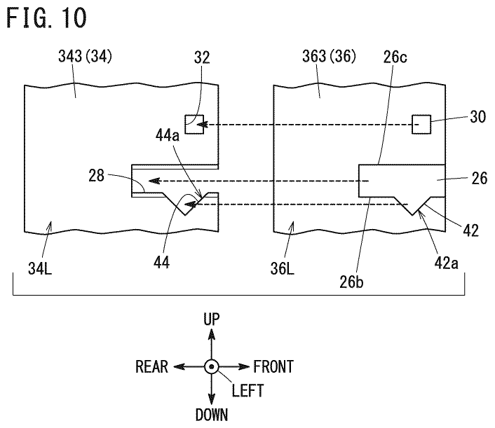

FIG. 10 is a diagram showing a module 363 (36) and a housing 343 (34) according to an Exemplary Modification 3. FIG. 10 shows a part of a left side portion 36L of the module 363 and a part of a left side portion 34L of the housing 343.

The module 363 includes the constituent elements of the module 36 (see the embodiment). The module 363 further includes a projecting portion 42. The module 363 may include a plurality of projecting portions 42.

The protruding direction of the projecting portion 42 coincides with the protruding direction of the protruding portion 30. Accordingly, in the example of FIG. 10, the projecting portion 42 protrudes in the left direction.

The projecting portion 42 is disposed on the same side of the module 363 as the dovetail tenon 26. For example, in the illustration of FIG. 10, the dovetail tenon 26 is at least disposed on a left side portion 36L of the module 363. Thus, the projecting portion 42 is disposed at least on the left side portion 36L of the module 363.

The projecting portion 42 is connected to the side portion of the dovetail tenon 26 in the direction perpendicular to the insertion direction, which is the extending direction of the side portion of the module 363 on which the dovetail tenon 26 is disposed. For instance, in the example of FIG. 10, the left side portion 36L of the module 363 extends in the front-rear direction and the up-down direction. The insertion direction is the rearward direction. The up-down direction among the front-rear direction and the up-down direction, is perpendicular to the rearward direction. In this case, the projecting portion 42 is connected to a lower side portion 26b or an upper side portion 26c of the dovetail tenon 26. The projecting portion 42 of FIG. 10 is connected to the lower side portion 26b.

The projecting portion 42 has an inclined surface 42a. The inclined surface 42a is a surface of the projecting portion 42 in the direction opposite to the insertion direction. Accordingly, in the example of FIG. 10, the inclined surface 42a is a frontward surface of the projecting portion 42. The inclined surface 42a is inclined from the dovetail tenon 26 in the rearward direction (insertion direction).

The housing 343 includes the constituent elements of the housing 34 (see the embodiment). The housing 343 is further formed with a notch 44 for engaging with the projecting portion 42.

The notch 44 has an edge portion 44a in the direction opposite to the insertion direction. In the example of FIG. 10, the edge portion 44a is a frontward edge portion of the notch 44. The edge portion 44a is preferably parallel to the inclined surface 42a in the case that the module 363 is inserted into the housing 343.

According to the present modification, in the case that the module 363 is accommodated in the housing 343, the inclined surface 42a of the projecting portion 42 slides in the insertion direction (rearward direction) along the edge portion 44a of the notch 44. Therefore, according to the present modification, the module 363 can be smoothly accommodated in the housing 343.

In the case that the module 363 is provided with a plurality of dovetail tenons 26, the module 363 may be provided with a plurality of projecting portions 42 corresponding to the plurality of dovetail tenons 26, respectively. However, the projecting portion 42 corresponding to at least one of the plurality of dovetail tenons 26 may be omitted.

### (Exemplary Modification 4)

The engagement structure 18 according to the present embodiment may be applied to members other than the terminal block 12. In short, the engagement structure 18 may be applied to other than the terminal block 12, within a range in which the accommodating member (34) including the opening (38) and the accommodated member (36) accommodated in the accommodating member (34) are engaged with each other by the accommodated member (36) being inserted into the opening (38) in the insertion direction.

### (Combination of Plural Exemplary Modifications)

The above-described respective exemplary modifications may be appropriately combined within a range in which no inconsistencies occur.

For example, the protruding portion 30 may be connected to one side of the dovetail tenon 26 in the up-down direction (Exemplary Modification 2), and the projecting portion 42 may be connected to another side of the dovetail tenon 26 in the up-down direction (Exemplary Modification 3).

### Invention Obtained from the Embodiment

Invention that can be grasped from the above-described embodiment and the exemplary modifications thereof will be described below.

### <First Aspect of Invention>

A first aspect of the invention is the engagement structure (18) for engaging the accommodating member (34) including the opening (38), with the accommodated member (36), the accommodated member (36) being accommodated in the accommodating member by being inserted into the opening in the insertion direction, the engagement structure including the latch structure (24) and the dovetail structure (22), wherein the latch structure includes the locking hole (32) formed in the accommodating member at the position spaced from the opening end (38a) of the opening in the insertion direction, and the protruding portion (30) provided on the accommodated member in accordance with the location of the locking hole in the accommodating member and configured to engage with the locking hole so as to restrict the relative movement of the accommodated member with respect to the accommodating member in the opposite direction that is opposite to the insertion direction, wherein the dovetail structure includes the dovetail tenon (26) provided at the end of the accommodated member, and the dovetail hole (28) formed in the accommodating member from the opening end in the insertion direction and configured to engage with the dovetail tenon while allowing the dovetail tenon to move to the predetermined position in the insertion direction, and wherein in the case that the accommodated member is inserted into the accommodating member, the dovetail tenon engages with the dovetail hole before the protruding portion and the opening end come into contact with each other.

In accordance with such features, any concern that the accommodated member may fall out of the accommodating member is reduced.

The tip (26a) of the dovetail tenon in the insertion direction may be located further in the insertion direction relative to the tip (30a) of the protruding portion in the insertion direction. In accordance with such features, the engagement on the dovetail structure side is started before the engagement on the latch structure side.

The protruding portion may be inclined in the manner so that the thickness of the protruding portion in the protruding direction is reduced in the insertion direction, and the tip (26a) of the dovetail tenon in the insertion direction may be located at the same position with respect to the insertion direction as the tip (30a) of the protruding portion in the insertion direction, or located further in the opposite direction relative to the tip of the protruding portion. In accordance with such features, the engagement on the dovetail structure side is started before the engagement on the latch structure side, and the engagement on the latch structure side is smoothly made.

The protruding portion and the dovetail tenon may be connected. In accordance with such features, any concern that the accommodated member may fall out of the accommodating member is reduced.

Two of the protruding portions may be provided so as to sandwich the dovetail tenon. In accordance with such features, any concern that the accommodated member may fall out of the accommodating member is reduced.

The engagement structure may further include the projecting portion (42) provided on the accommodated member and connected to the side portion (26b) of the dovetail tenon in the direction perpendicular to the insertion direction, and the notch (44) provided in the accommodating member and configured to engage with the projecting portion, wherein the projecting portion may include the inclined surface (42a) on the side in the opposite direction, the inclined surface being inclined in the insertion direction from the dovetail tenon, and the notch may include the edge portion (44a) on the side in the opposite direction, the edge portion being inclined in the insertion direction from the dovetail hole. In accordance with such features, the accommodation operation can be facilitated.

### <Second Aspect of Invention>

The terminal block (12) is equipped with the housing (34) including the opening (38), and the module (36) that is accommodated in the housing by being inserted into the opening in the insertion direction, the terminal block including the locking hole (32) formed in the housing at the position spaced from the opening end (38a) of the opening in the insertion direction, the protruding portion (30) provided on the module in accordance with the location of the locking hole in the housing and configured to engage with the locking hole so as to restrict relative movement of the module with respect to the housing in the opposite direction that is opposite to the insertion direction, the dovetail tenon (26) provided at the end of the module, and the dovetail hole (28) formed in the housing from the opening end in the insertion direction and configured to engage with the dovetail tenon while allowing the dovetail tenon to move to the predetermined position in the insertion direction, wherein in the case that the module is inserted into the housing, the dovetail tenon engages with the dovetail hole before the protruding portion and the opening end come into contact with each other.

In accordance with such features, any concern that the module may fall out of the housing is reduced.

### Reference Signs List

10: I/O unit
12: terminal block
18: engagement structure
20: external terminal
22: dovetail structure
24: latch structure
26: dovetail tenon
26a: tip of dovetail tenon (tip)
26b: lower side portion of the dovetail tenon (side portion)
26c: upper side portion of dovetail tenon (side portion)
28: dovetail hole
30, 301: protruding portion
30a: tip of the protruding portion (tip)
32: locking hole
34, 342, 343: housing
36, 361 to 363: module
38: opening
42: projecting portion
42a: inclined surface of the projecting portion (inclined surface)
44: notch
44a: edge portion of notch (edge portion)
401: terminal

1. An engagement structure for engaging an accommodating member including an opening, with an accommodated member, the accommodated member being accommodated in the accommodating member by being inserted into the opening in an insertion direction,
the engagement structure comprising a latch structure and a dovetail structure,
wherein the latch structure includes:
a locking hole formed in the accommodating member at a position spaced from an opening end of the opening in the insertion direction; and
a protruding portion provided on the accommodated member in accordance with a location of the locking hole in the accommodating member and configured to engage with the locking hole so as to restrict relative movement of the accommodated member with respect to the accommodating member in an opposite direction that is opposite to the insertion direction,
wherein the dovetail structure includes:
a dovetail tenon provided at an end of the accommodated member; and
a dovetail hole formed in the accommodating member from the opening end in the insertion direction and configured to engage with the dovetail tenon while allowing the dovetail tenon to move to a predetermined position in the insertion direction, and
wherein in a case that the accommodated member is inserted into the accommodating member, the dovetail tenon engages with the dovetail hole before the protruding portion and the opening end come into contact with each other.

2. The engagement structure according to claim 1, wherein a tip of the dovetail tenon in the insertion direction is located further in the insertion direction relative to a tip of the protruding portion in the insertion direction.

3. The engagement structure according to claim 1,
wherein the protruding portion is inclined in a manner so that a thickness of the protruding portion in a protruding direction is reduced in the insertion direction, and
a tip of the dovetail tenon in the insertion direction is located at a same position with respect to the insertion direction as a tip of the protruding portion in the insertion direction, or located further in the opposite direction relative to the tip of the protruding portion.

4. The engagement structure according to claim 1, wherein the protruding portion and the dovetail tenon are connected.

5. The engagement structure according to claim 1, wherein two of the protruding portions are provided so as to sandwich the dovetail tenon.

6. The engagement structure according to claim 1, further comprising:
a projecting portion provided on the accommodated member and connected to a side portion of the dovetail tenon in a direction perpendicular to the insertion direction; and
a notch provided in the accommodating member and configured to engage with the projecting portion,
wherein the projecting portion includes an inclined surface on a side in the opposite direction, the inclined surface being inclined in the insertion direction from the dovetail tenon, and
the notch includes an edge portion on a side in the opposite direction, the edge portion being inclined in the insertion direction from the dovetail hole.

7. A terminal block equipped with a housing including an opening, and a module that is accommodated in the housing by being inserted into the opening in an insertion direction, the terminal block comprising:
a locking hole formed in the housing at a position spaced from an opening end of the opening in the insertion direction;
a protruding portion provided on the module in accordance with a location of the locking hole in the housing and configured to engage with the locking hole so as to restrict relative movement of the module with respect to the housing in an opposite direction that is opposite to the insertion direction;
a dovetail tenon provided at an end of the module; and
a dovetail hole formed in the housing from the opening end in the insertion direction and configured to engage with the dovetail tenon while allowing the dovetail tenon to move to a predetermined position in the insertion direction,
wherein in a case that the module is inserted into the housing, the dovetail tenon engages with the dovetail hole before the protruding portion and the opening end come into contact with each other.
